(19) United States
(12) Patent Application Publication
(10) Pub. No.: US 2008/0114918 A1
(43) Pub. Date: May 15, 2008

(54) Configurable computer system

(75) Inventors: Ravi B. Bingi, Austin, TX (US); Ranger H. Lam, Austin, TX (US); Thomas Madaelil, Austin, TX (US); Lloyd W. Gauthier, Austin, TX (US); Brian E. Longhenry, Austin, TX (US); Kristy M. Cates, Austin, TX (US); Christopher E. Tressler, Austin, TX (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/595,637

(22) Filed: Nov. 9, 2006

(51) Int. Cl. G06F 13/00

(52) U.S. Cl. 710/300

(57) ABSTRACT

A method for providing multiple configurations for a computer system. The method provides interconnection of processor boards in a first configuration and a second configuration. In the first configuration, a first plurality of processor boards are interconnected through a first backplane. In a second configuration, a second plurality of processor boards are interconnected through a second backplane. The first and second pluralities of processor boards are interchangeable with each other.

### BACKGROUND OF THE INVENTION

1. Field of the Invention

This invention relates to computer systems, and more particularly, to reconfigurable computer systems.

2. Description of the Related Art

The proliferation of computer networks in recent years has increased the demand for server systems. Server systems can be implemented in local area networks, wide area networks, internet service providers, storage systems, and the like. The variety of networks has correspondingly resulted in a wide variety of server systems available on the market.

While some server systems include only a single processor, many utilize multiple processors. In server systems utilizing multiple processors, it may be necessary for the processors to communicate with each other for various reasons (e.g., maintaining cache coherency, sharing the application load, etc.). Various topologies may be implemented for coupling the processors in a manner that enables them to communicate with each other.

At times, it may be desirable to change the configuration of a server. For example, an expanding business may need to increase the number of computers coupled to its local area network, and may in turn need to implement more processing power in the network server(s). Increasing the processing power may be more than a simple matter of adding processors to the server system. Since it may be necessary for the processors to communicate with each other, the addition of processors may require conformance to a topology that enables them to do so. This may be difficult, if not impossible, given that such a change could require a significant rerouting of the system board. Thus, the addition of processing power may require the replacement of a server instead of a mere addition of processors.

### SUMMARY OF THE INVENTION

A method for providing multiple configurations for a computer system is disclosed. In one embodiment, the method provides interconnection of processor boards in a first configuration and a second configuration. In the first configuration, a first plurality of processor boards are interconnected through a first backplane. In a second configuration, a second plurality of processor boards are interconnected through a second backplane. The first and second pluralities of processor boards are interchangeable with each other. This allows the changing of a system configuration by changing the backplane with no other hardware changes. For example, in one embodiment, a system having 8 processors (with 8-bit interconnections) can be reconfigured to a system having 4 processors (with 16-bit interconnections) by simply changing the backplane.

In one embodiment, the interconnections for both of the first and second processors are direct, point-to-point links. The point-to-point links may comply with a point-to-point protocol (e.g., such as the HyperTransport™ protocol). Through this interconnection topology, each processor may have a direct link to every other processor, or in other words, the link is shared only by the two processors linked together and is thus a “one-hop” topology. This is in contrast to topologies that are not fully connected, and thus involve at least 2 hops to another processor (i.e. a first processor connecting to a second processor via a third processor). Thus, each processor can directly communicate with any other processor with no dependency on a third processor, thereby reducing system latency.

The interconnections between processors may be of various bit-widths. For example, in the first configuration, each interconnection may be eight bits wide, while in the second configuration (with fewer processor boards than the first configuration), the interconnections may be doubled up to form sixteen bit interconnections. Also contemplated are configurations wherein some of the interconnections are sixteen bits wide while others are eight bits wide.

### BRIEF DESCRIPTION OF THE DRAWINGS

Other aspects of the invention will become apparent upon reading the following detailed description and upon reference to the accompanying drawings in which:

FIG. 1 is a perspective view of one embodiment of a computer system including a backplane and a plurality of processor cards;

FIG. 2 is a block diagram of one embodiment of a server system including a plurality of processors each linked to each other;

FIG. 3 is a block diagram of another embodiment of a server system including a plurality of processors each linked to each other;

FIG. 4 is a diagram of one embodiment of a processor board having a processor mounted thereupon; and

FIG. 5 is a flow diagram illustrating one embodiment of a method for changing the configuration of a server system.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling with the spirit and scope of the present invention as defined by the appended claims.

### DETAILED DESCRIPTION OF THE INVENTION

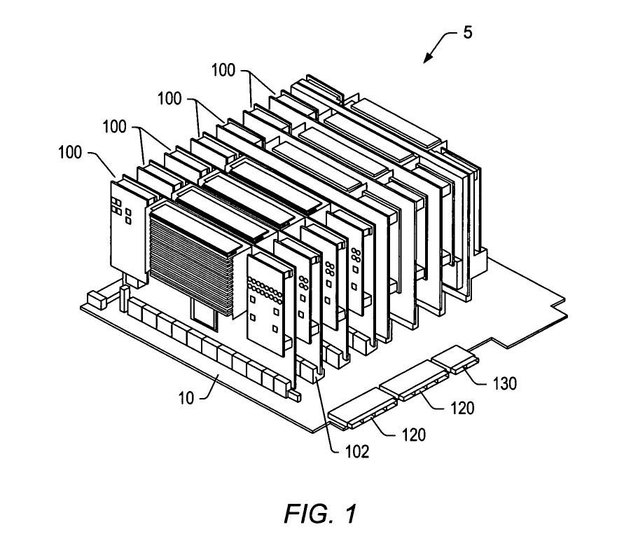

Turning now to FIG. 1, a perspective view of one embodiment of a computer system including a backplane and a plurality of processor cards is shown. In the embodiment shown, the computer system is a server system, although other types of computer systems are also possible within the scope of this disclosure.

Server system 5 is a computer system including a backplane 10 having a plurality of connectors 102 mounted thereupon. Each of a plurality of processor boards 100 is coupled to backplane 10 by a corresponding connector 102. In this particular embodiment, there are eight connectors 102 mounted to backplane 10, and eight processor boards 100 coupled to the backplane via the connectors. Embodiments having a different number of connectors (and thus, a different number of processor boards) are possible and contemplated. Furthermore, embodiments wherein some connectors may be unoccupied (i.e. a system configuration wherein six processors are connected to a backplane having eight connectors and thus the capacity to accommodate eight processors) are also possible and comtemplated.

Server system 5 also includes one or more I/O connectors 120, which may accommodate various devices capable of communicating with the processor boards 100. Such devices may include disk drives, optical disk drives (e.g., DVD-ROM drives), monitors, printers, and other types of peripherals.

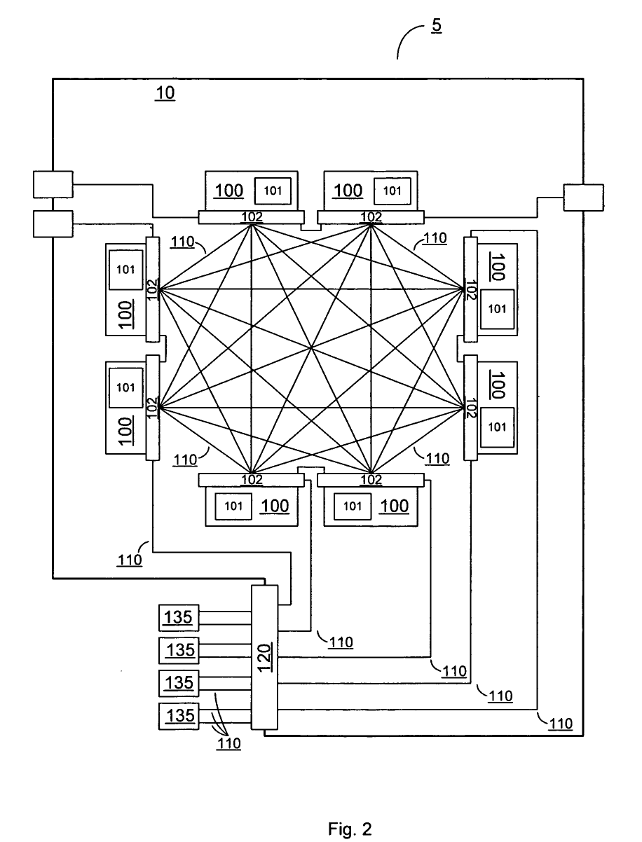

FIG. 2 is a block diagram of one embodiment of a server system including a plurality of processors each linked to each other. In the embodiment shown, server system 5 includes eight processor boards 100, each coupled to backplane 10 via a corresponding connector 102. Each processor board 100 includes a processor 101 mounted thereupon. In addition to the processor, each processor board 100 may also include memory and various connectors (e.g., power connectors) for enabling board functionality.

Backplane 10 is configured to accommodate a plurality of inter-processor links 110. In the embodiment shown, each link 110 is a point-to-point, clock-forwarded link. Each processor 101 includes a plurality of link interfaces each configured to couple to a link 110. Through the topology of the links 110, each processor 101 shares a direct point-to-point link with every other processor 101. In contrast to a bussed link between two processors (which may be shared by additional processors as well as other devices), each point-to-point link is shared only by two processors, and thus allows communication between them without arbitration with other processors. This type of interconnection topology may result in a significant performance improvement over topologies where a number of processors share the same, bussed link. For a given processor 101 having eight link interfaces, seven of these link interfaces may be used to couple the processor to the other seven processors via a point-to-point link. The point-to-point links establish a “one-hop” topology, whereby each processor can communicate directly with any other processor without being dependent upon a third, intervening processor.

In the embodiment of FIG. 2, each point-to-point link is eight bits wide, although links of other widths are possible and contemplated. Thus each processor 101 in this embodiment has direct 8-bit links to every other processor in the system, and each link is coupled to a processor through a separate link interface (an embodiment of a processor will be discussed in further detail below). In this example, each of the point-to-point links may conform to the HyperTransport™ protocol, and further, may conform to the HT3 (HyperTransport™ 3.0) protocol. Embodiments utilizing links of other protocols, including various types of clock-forwarded links, are also possible and contemplated.

In addition to the links between the processors, each processor 101 has a link to an I/O connector 120, which in turn may be linked to an I/O device 135 by a link 110. These links 110 may be of the same protocol of the inter-processor links 110 on backplane 10, and may allow for the coupling of peripheral devices to the processors of computer system 5. Additional I/O devices (beyond those shown here) may also be linked to the processors in accordance with the protocol of the links 110. Thus, each of the processors 101 may have a direct link to every other processor 101 in the system as well as direct, point-to-point links to various I/O devices 135.

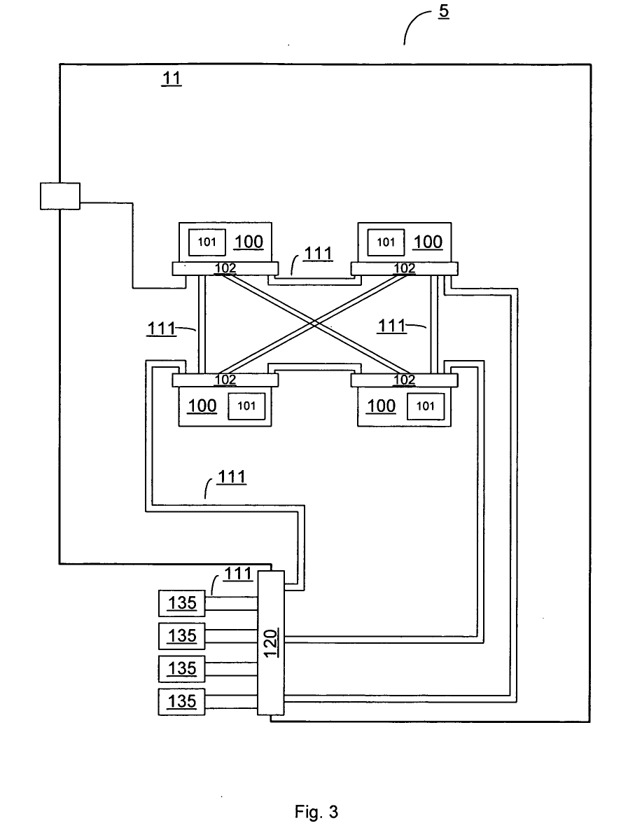

FIG. 3 is a block diagram of another embodiment of a server system including a plurality of processors each linked to each other. In this particular embodiment, backplane 11 accommodates up to four processor boards 100, and thus four processors 101. However, this embodiment may take advantage of one of the properties of a point-to-point link protocol that enables some links to be combined, or “ganged” to form a higher bandwidth link. In this particular embodiment, each link 111 includes two 8-bit links combined together to form a 16-bit link. Similarly, links 111 between processor boards 100 and I/O connector(s) 120 are also 16 bits wide. Thus, while this embodiment has fewer processors 101, it may enable higher throughput for inter-processor communications via the increased bandwidth of links 111 (with respect to the 8-bit links 110 shown in the embodiment of FIG. 2).

Embodiments are also possible and contemplated wherein some of the inter-processor links are wider than other inter-processor links. For example, embodiments are possible wherein a processor shares a 16-bit link with at least a first other processor in the system and an 8-bit link with at least a second other processor in the system. Embodiments including an odd number of processor boards, which may include links of differing bit-widths (e.g., at least one 16-bit link and at least one 8-bit link) are also possible and contemplated.

Configuration changes from the embodiment shown in FIG. 2 to that of FIG. 3 (or vice versa) may be accomplished by replacing the backplane. For example, the embodiment of FIG. 2 may easily be changed to that of FIG. 3 by removing the processor boards 100 from backplane 10, replacing backplane 10 with backplane 11, and connecting four of the eight processor boards 10 to backplane 11. Similarly, a configuration change from the embodiment of FIG. 3 to that of FIG. 2 is also possible by removing the processor boards 100 from backplane 11, replacing backplane 11 with, backplane 10, and connecting the four processor boards 100 along with four additional processor boards to backplane 10. It should be noted that the exact same processor boards need not be used in a configuration change, although the processor boards in general will be interchangeable with each other.

It should also be noted that the examples of FIGS. 2 and 3 are exemplary and do not represent all of the possible embodiments of configurable computer systems in accordance with this disclosure. The number of processor boards for a backplane is limited only by its design, and there is no theoretical upper limit to how many processor boards a backplane may be designed to accommodate. Similarly, the number of processors that may communicate with each other through direct point-to-point links is limited only by the design of the processors, processor boards, and communications protocol (along with the backplane designs). In general, any configuration change for the systems disclosed herein may be made by changing the backplane board while using a number of interchangeable processor boards. A configuration change increasing the number of processors in a system (beyond the number for which a specific backplane may accommodate) may be accomplished by changing the backplane and coupling thereto an increased number of processor boards, including either the original processor boards (prior to changing configuration) or a plurality of processor boards interchangeable with the original processor boards. A configuration change decreasing the number of processors in a system may be accomplished by changing the backplane and coupling thereto a plurality of processor boards including either a subset of those present in the original configuration or a plurality of processor boards interchangeable with those originally present. Furthermore, as discussed per the different configurations shown in FIGS. 2 and 3, a configuration change may include changing the processor interconnections from a first bit-width to a second bit-width, wherein one of the bit-widths is greater than the other.

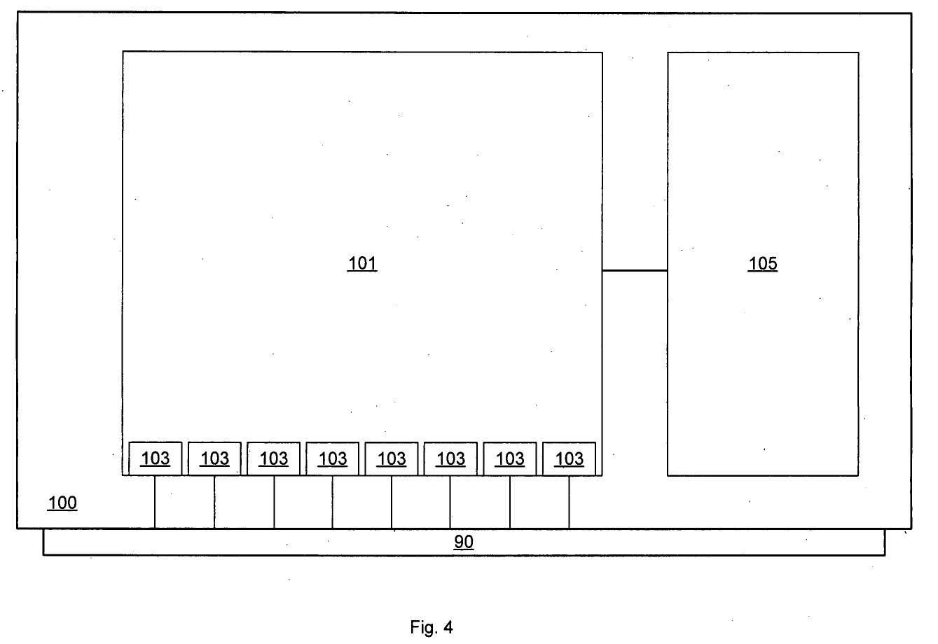

FIG. 4 is a diagram of one embodiment of a processor board having a processor mounted thereupon. In the embodiment shown, processor board 100 includes processor 101 and memory 105. Memory 105 may be any type of suitable memory (e.g., dynamic random access memory, or DRAM) for providing storage necessary concurrent with processor operations. Processor board 100 also includes a connector 90 which enables it to be coupled to a backplane. The connector may be a card edge connector or any other type suitable for coupling it to a corresponding backplane.

Processor 101 in the embodiment shown includes a plurality of interfaces 103 which are used to enable the point-to-point links with other processors and I/O connections. For example, in one embodiment interfaces 103 are HyperTransport™ interfaces, and more particularly, an HT3 interfaces. As such, interfaces are eight bits wide in this particular embodiment, although other bit-widths are possible and contemplated. As previously noted, in embodiments such as that shown in FIG. 3 the links may be combined to produce double-wide (e.g. 16-bit) links, and correspondingly, the interfaces 103 are also functionally combined to produce a double-wide interface. In embodiments such as that shown in FIG. 2, each interface may enable a link that is functionally separate from the other links, with each link (and thus each interface) being eight bits wide. Links of other widths than those explicitly disclosed herein are also contemplated, including serial links.

Each processor board 100 may be interchangeable with other instances of processor board 100. Thus, even if one processor board 100 is not identical with another processor board 100 in every respect, it may be functionally interchangeable such that it may be used in a number of different embodiments/configurations, and may further be re-utilized when from one configuration to another (e.g., may be used in the configurations of both FIG. 2 and FIG. 3 and any configuration change therebetween).

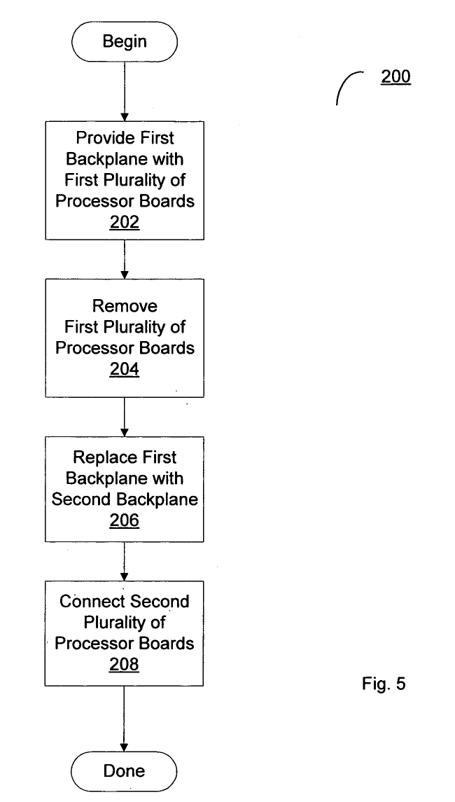

FIG. 5 is a flow diagram illustrating one embodiment of a method for changing the configuration of a server system. In the embodiment shown, method 200 begins with the provision of a computer (e.g., server) system having a first backplane and a first plurality of processor boards (202). Changing the configuration may be initiated by removing (i.e. disconnecting) the first plurality of processor boards from the first backplane (204). Once the first plurality of processor boards has been removed, the first backplane may be replaced by a second backplane configured to accommodate a different number of processor boards than the first backplane (206). The number of processor boards that the second backplane can accommodate may be greater or lesser than the number that may be accommodated by the first backplane. Once the first backplane has been replaced by the second backplane, the configuration change may proceed by coupling a second plurality of processor boards to the second backplane (208).

The second plurality of processor boards may include one or more of the first plurality of processor boards and/or include a plurality of processor boards that is interchangeable with the first plurality. For example, if changing the configuration from a 4-processor system to an 8-processor system, the four processor boards of the first system may be combined with four additional (and interchangeable) processor boards to create the second plurality. In another example, if changing the configuration from an 8-processor system to a 4-processor system, the second plurality of processor boards may be comprised of four of the processor boards from the first plurality. Alternatively, the same processor boards need not be used in a configuration change, wherein the second plurality of processor boards may comprise a separate plurality of processor boards, each being interchangeable with any processor board of the first plurality.

Although the systems and methods discussed herein have been directed to server systems, the disclosure is not intended to be limiting as such. The systems and methods discussed herein may be applied to any computer system having a backplane configured to receive a processor board, regardless of the intended use of the computer system.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method of providing multiple configurations of a computer system, the method comprising:
in a first configuration, interconnecting a first plurality of processor boards through a first backplane, wherein each of the first plurality of processor boards includes a processor mounted thereupon, and wherein, via the first backplane, each processor has an interconnection to every other processor; and
in a second configuration, interconnecting a second plurality of processor boards through a second backplane, wherein each of the second plurality of processor boards includes a processor mounted thereupon, and wherein, via the second backplane, each processor has an interconnection to every other processor;
wherein a number of processor boards in the second plurality is less than a number of processor boards in the first plurality; and
wherein the each of the first plurality of processor boards is interchangeable with each of the second plurality of processor boards.

2. The method as recited in claim 1, wherein the interconnections between the processors are direct point-to-point links.

3. The method as recited in claim 2, wherein the point-to-point links comply with the HyperTransport™ protocol.

4. The method as recited in claim 2, wherein each of the direct point-to-point links is a clock-forwarded link.

5. The method as recited in claim 1, wherein, in the first configuration, each interconnection has a first bit-width, and wherein, in the second configuration, each interconnection has a second bit-width, wherein the second bit-width is greater than the first bit-width.

6. The method as recited in claim 5, wherein the first configuration includes eight processor boards, and wherein each interconnection is eight bits in width.

7. The method as recited in claim 5, wherein the second configuration includes four processor boards, and wherein each of the interconnections is sixteen bits in width.

8. The method as recited in claim 5, wherein the first configuration includes an odd number of processor boards, and wherein at least a first interconnection has a first bit-width and at least a second interconnection has a second bit-width.

9. The method as recited in claim 8, wherein the first interconnection is sixteen bits in width, and wherein the second interconnection is eight bits in width.

10. The method as recited in claim 1, wherein the first and second backplanes includes a first and a second plurality of I/O (input/output) ports, respectively.

11. The method as recited in claim 10, wherein, in the first configuration, each of the first plurality of processors has an interconnection with a corresponding one of the first plurality of I/O ports, and wherein, in the second configuration, each of the second plurality of processors has an interconnection with a corresponding one of the second plurality of I/O ports.

12. The method as recited in claim 11, wherein each of the interconnections is a point-to-point link.

13. The method as recited in claim 12, wherein the point-to-point links comply with the HyperTransport™ protocol.

14. The method as recited in claim 1, wherein the computer system is a server system.

15. A method for changing the configuration of a computer system, the method comprising:
providing a first backplane in the computer system and a first plurality of processor boards coupled thereto, wherein each of the first plurality of processor boards includes a processor mounted thereupon, and wherein, via the first backplane, each processor has an interconnection to every other processor removing the first plurality of processor boards from the first backplane;
removing the first backplane from the computer system;
replacing the first backplane with a second backplane; and
coupling a second plurality of processor boards to the second backplane, wherein the second plurality is a subset of the first plurality, wherein each of the second plurality of processor boards includes a processor mounted thereupon, and wherein, via the second backplane, each processor has an interconnection to every other processor.

16. The method as recited in claim 15, wherein the interconnections between the processors are direct point-to-point links.

17. The method as recited in claim 16, wherein the point-to-point links comply with the HyperTransport™ protocol.

18. A method of for changing the configuration of a computer system, the method comprising:
providing a first backplane in the computer system and a first plurality of processor boards coupled thereto, wherein each of the first plurality of processor boards includes a processor mounted thereupon, and wherein, via the first backplane, each processor has an interconnection to every other processor removing the first plurality of processor boards from the first backplane;
removing the first backplane from the computer system;
replacing the first backplane with a second backplane; and
coupling a second plurality of processor boards to the second backplane, wherein the second plurality includes each of the first plurality of processor boards and an additional plurality of processor boards, wherein each of the additional plurality of processor boards includes a processor mounted thereupon, and wherein, via the second backplane, each processor has an interconnection to every other processor

19. The method as recited in claim 18, wherein the interconnections between the processors are direct point-to-point links.

20. The method as recited in claim 19, wherein the point-to-point links comply with the HyperTransport™ protocol.
